(19) United States
(12) Patent Application Publication
(10) Pub. No.: US 2024/0232267 A1
(43) Pub. Date: Jul. 11, 2024

(54) METHOD, APPARATUS AND COMPUTER READABLE MEDIA FOR PRESERVATION OF CLOUD OBJECT METADATA OUTSIDE OF CLOUD ENVIRONMENT

(71) Applicant: Capital One Services, LLC, McLean, VA (US)

(72) Inventors: Paul Warner, Reston, VA (US); Sam Walczak, Columbia, MD (US); Joel Sop, Arlington, VA (US); Julia Pennington, Austin, TX (US); Collin Berman, Snoqualmie, WA (US); Nikhil Srikanth, Richmond, VA (US)

(21) Appl. No.: 18/150,879

(22) Filed: Jan. 6, 2023

(51) Int. Cl. G06F 16/93; G06F 16/906

(52) U.S. Cl. CPC G06F 16/93; G06F 16/906

(57) ABSTRACT

Methods, computer readable media, and apparatuses are provided herein for preserving custom metadata associated with an object (e.g., document) stored on a cloud data storage platform. An illustrative method may comprise receiving audit logs generated by the cloud data storage platform, and determining that the audit logs indicate a document exit event occurred from the cloud data storage platform. Further, the method may comprise storing in a cache memory, a document identifier associated with the document exit event, obtaining, based on the audit logs, custom metadata related to a document associated with the document exit event, and storing the custom metadata in association with the document identifier.

### FIELD OF USE

Aspects of the disclosure relate generally to data preservation of objects removed from a cloud storage platform. More specifically, aspects of the disclosure may provide for a method, apparatus, and computer readable media for preserving object metadata when an object leaves or is removed from (e.g., downloaded) a cloud data storage platform so that the object metadata is available outside the cloud data storage platform.

### BACKGROUND

Documents created and stored in a cloud data storage platform have several types of metadata including default metadata and custom metadata. For example, documents stored in cloud storage are provided with default metadata such as document name, created at time, last modified time, generation number of the object (document) and document size. Custom metadata is metadata where the user defines the values that may be applied.

When a user downloads the document to their local computer outside of the cloud data storage platform, the custom metadata is no longer associated with the document. That is, the custom metadata is lost such that other applications, the user and other third parties cannot use the custom metadata of the document outside the cloud data storage platform.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for a preservation mechanism in which custom metadata that is associated with objects stored on a cloud storage platform can be preserved, which would otherwise be lost, when the object leaves or is removed from the cloud data storage platform.

According to aspects of the disclosure an illustrative method to preserve custom metadata associated with an object (e.g., document) stored on a cloud data storage platform comprises receiving audit logs generated by the cloud data storage platform, and determining that the audit logs indicate a document exit event occurred from the cloud data storage platform. Further, the method may comprise storing in a cache memory, a document identifier associated with the document exit event, obtaining, based on the audit logs, custom metadata related to a document associated with the document exit event, and storing the custom metadata in association with the document identifier.

The method may further comprise exposing to data loss prevention tools: the document identifier, and the custom metadata stored in association with the document identifier in the cache memory and receiving, from the data loss prevention tools and based on a function performed on the exposed document identifier and the exposed custom metadata by the data loss prevention tools, instructions for managing the document. The custom metadata may comprise one or more classification labels. The one or more classification labels may comprise at least one of sensitivity labels or retention labels.

In certain aspects of the disclosure the document exit event may comprise at least one of downloading the document or emailing the document. The document identifier may comprise a name of the document. In some aspects, determining that the audit logs indicate a document exit event may comprise detecting a download of a document marked for legal hold, or a highly sensitive document. In other aspects, determining that the audit logs indicate a document exit event may comprise parsing the audit logs for document exit events.

According to some aspects, storing the document identifier associated with the document exit event comprises storing document identifiers of documents associated with document exit events in the cache memory. In some aspects, the method may further comprise providing, based on a data loss prevention API request, the document identifiers for the documents associated with the document exit events to data loss prevention tools. The document identifiers may comprise providing a document name for the documents associated with the document exit events, providing the custom metadata for a specific document identifier, the classification labels for a specific document identifier, providing the names of the documents associated with the document exit events for a specific classification label, and/or providing the names configured to be input for data match functionality tools.

Corresponding method, apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a control processing system that may be used in implementing one or more aspects of the disclosure in accordance with one or more illustrative aspects discussed herein;

FIG. 2 depicts a system diagram showing an illustrative cloud data storage platform, and an environment (e.g., enterprise) for maintaining metadata with an object outside the cloud data storage platform and allowing the object metadata to be used with data loss prevention tools in accordance with one or more illustrative aspects discussed herein;

FIG. 3 depicts an illustrative process for implementing one or more aspects of the disclosure in accordance with one or more illustrative aspects discussed herein.

### DETAILED DESCRIPTION

In the following description of the various implementations, reference is made to the accompanying drawings, which form a part hereof, and in which is shown by way of illustration various implementations in which aspects of the disclosure may be practiced. It is to be understood that other implementations may be utilized and structural and functional modifications may be made without departing from the scope of the present disclosure. Aspects of the disclosure are capable of other implementations and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to method and techniques used by a system, such as an enterprise, to prevent the loss of metadata associated with objects stored on a cloud data storage platform when the object is removed from the platform in cases in which the metadata would otherwise been lost and not accessible when the object is outside the platform. While the method and techniques disclosed herein apply to various types of objects including, for example, images, video, audio, documents and the like, the following disclosure will discuss a specific example in which the object is a document. Additionally, the cloud data storage platform or cloud storage platform may be any type of known cloud storage platform including, but not limited to, the current market leaders, Microsoft 365® (which includes cloud storage OneDrive®) and Google Workspace® (which includes cloud storage Google Drive®). For purposes of the disclosure, examples will be provided with Google Workspace (GWS) as the cloud data storage platform, but it will be understood that aspects of the disclosure may be applied to any cloud storage platform.

Many objects are created and stored on a cloud data storage platform. For example, objects (e.g., documents) such as Google Docs® and Google Sheets® can be created and stored in cloud storage such as Google Drive®, all of which may be part of a cloud data storage platform like Google Workspace®. Google Workspace (GWS) is a collection or suite of cloud computing based productivity and collaboration tools including, among others, Google Drive, Google Docs, Google Sheets, custom email addresses, and other administrative tools and advanced functionality.

Certain types of metadata available for objects created in a cloud data storage platform may be default metadata. For example, for a document in GWS, default metadata may include document name, created at time, last modified time, generation number of the object (document) and document size. Another type of metadata available for objects stored in cloud storage on a cloud storage platform is custom metadata. For example, for documents in GWS that are stored in Google Drive, the user may define custom metadata using a software tool to create fields and assign values to those fields for each document. For example, a user may create custom metadata using third-party software, using a Google Apps Script® and Google Drive Advanced Service®, or using the Google Drive API.

The custom metadata is stored differently than default metadata and when a document exits (e.g., is removed from, downloaded or sent as an email attachment) the cloud data storage platform, the default metadata is not exported with the document outside of the cloud data storage platform while the default metadata remains associated with the document. Thus, the custom metadata is lost once the document exits the cloud data storage platform and cannot be accessed.

In one example, an enterprise may have a spreadsheet (in Google Sheets) stored on a cloud storage platform (e.g., Google Drive on GWS) with a list of customers that includes customer attributes like name, address, social security number, account number, etc. Due to the sensitivity of such information, the business may want to limit who can access the spreadsheet from Google Drive and what actions those that can access the spreadsheet are permitted to perform. This can be achieved by the document creator who can define a data classification label as metadata for the document. A data classification label may be, for example, a sensitivity label, which may identify the permissions or sensitivity associated with the document and may have a value of, for example, “highly confidential”, “confidential” or “not confidential”. Many different tiers of access rights could be defined.

When a user attempts to access, on the cloud data storage platform, the spreadsheet that has a data classification label of “highly confidential”, a determination is made as to whether the user is authorized (e.g., has access rights) to access the document and what actions the user is permitted to perform. This scheme prevents unauthorized users from accessing “highly confidential” documents as well as prevents users who can access the document from performing actions that they do not have permission to perform. For example, a user who can access the “highly confidential” document may have view only permission while another user may not have permission to edit the document on the cloud storage platform, but may be able to download to their local computer or print the document.

When a user who has permission to download the document to their local computer or email the document as an attachment outside of the cloud data storage platform, the custom metadata (e.g., the data classification label) is no longer associated with the document. That is, in this example, the data classification is lost such that other applications, the user and other third parties are not subjected to the data classification restrictions that are associated with the document on the cloud data storage platform. The loss of the custom metadata can present a risk that a document could be used in ways and by parties contrary to the intent of the document creator.

Aspects described herein generally enable custom metadata to remain with an object such as a document when the object is removed (e.g., downloaded or emailed as an attachment) from the cloud data storage platform, thereby maintaining the security of the object when the object is outside of the cloud data storage platform.

Aspects of the disclosure provide illustrative techniques to preserve the custom metadata when a document exits the cloud data storage platform. In illustrative aspects of the disclosure, cloud storage platform audit logs (e.g., GWS audit logs) are collected and streamed through an existing process. Aspects involve the enterprise intercepting exit events (e.g., download) from the logs and processing the object events to capture the metadata and document ID and compile a cache of the document download events and metadata (e.g., data classification labels) applied to the documents. By preserving (storing) the document ID with the metadata in a centralized cache outside the cloud storage platform, the metadata, which would otherwise have been lost due to the document exiting (e.g., being downloaded) from GWS can be preserved. This allows a data loss prevention (DLP) API to expose the data from the cache in a format that is utilized by various software processes including, but not limited to, internal and third party DLP tools, additional custom code, and other integrations.

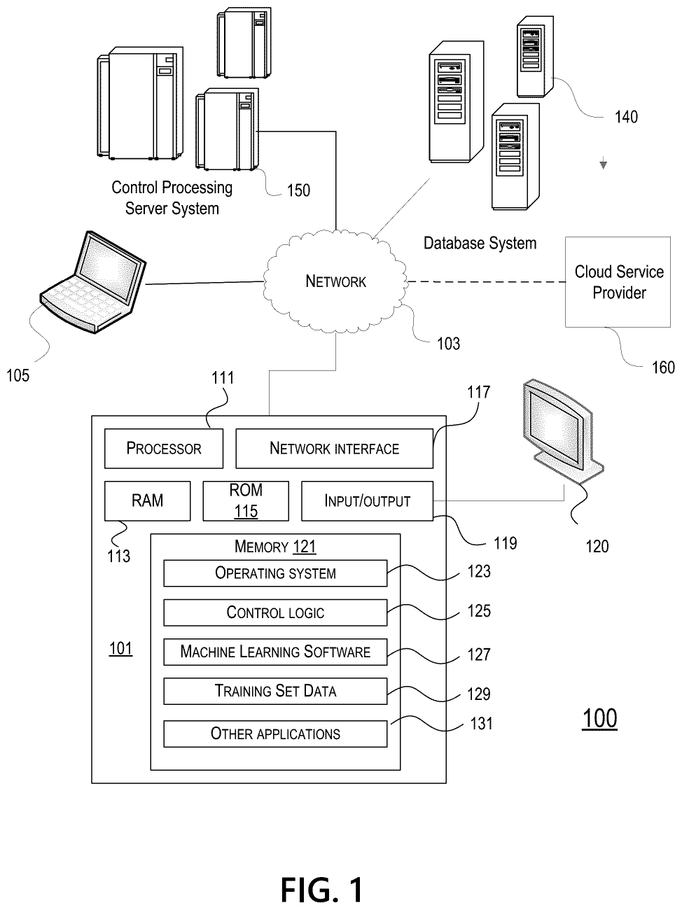

Before discussing these concepts in greater detail, however, several examples of a system 100 that may be used in implementing and/or otherwise providing various aspects of the disclosure, for example, in an enterprise environment that may interface with an enterprise cloud service provider, will first be discussed with respect to FIG. 1.

FIG. 1 illustrates one example of a system that may be used to implement one or more illustrative aspects discussed herein. The system 100 may include at least one computing device 101, at least one database system 140, and/or at least one server system 150 in communication via a network 140. In some aspects, the system 100 may be connected to a cloud service provider 150 (Google Cloud®, Amazon Web Services®, etc.), which provides cloud services for the enterprise.

The computing device 101 may, in some implementations, implement one or more aspects of the disclosure by reading and/or executing instructions and performing one or more actions based on the instructions. In other aspects, the computing device 101 may operate in conjunction with one or more of database system 140, control processing server system 150, and cloud service provider 160. In some aspect, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some aspects, operate in a standalone environment. In others, computing device 101 may operate in a networked environment. As shown in FIG. 1, computing devices 101, 105 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. The network 140 may include a local area network (LAN), a wide area network (WAN), a wireless telecommunications network, and/or any other communication network or combination thereof. The network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Devices 101, 105 and other devices (not shown) may be connected to one or more of the networks via twisted pair wires, coaxial cable, fiber optics, radio waves or other communication media.

Database systems 140 may perform data retrieval and storage actions as described herein. Databases may include, but are not limited to relational databases, hierarchical databases, distributed databases, in-memory databases, flat file databases, XML databases, NoSQL databases, graph databases, and/or a combination thereof. Control processing server systems 150 may perform functions of enterprise servers as described herein.

The data transferred to and from various computing devices in the system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. The cloud service provider 150 may be accessed by authorized external devices and users to support input, extraction, and manipulation of data between the various computing devices in the system 100. Web services of the cloud service provider 150 can be built to support a personalized display system, may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in the system 100 in front of one or more computing devices such that any external devices may communicate directly with the specialized hardware.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129. Control logic 125 may be incorporated in and may be a part of machine learning software 127, and other applications 131. In other aspects, computing device 101 may include two or more of any and/or all of these components (e.g., two or more processors, two or more memories, etc.) and/or other components and/or subsystems not illustrated here.

Device 105 may have similar or different architecture as described with respect to computing device 101. Those of skill in the art will appreciate that the functionality of computing device 101 (or device 105,) as described herein may be spread across multiple data processing devices, for example, to distribute processing load across multiple computers, to segregate transactions based on geographic location, user access level, quality of service (QOS), etc. For example, computing devices 101, 105, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various aspects. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

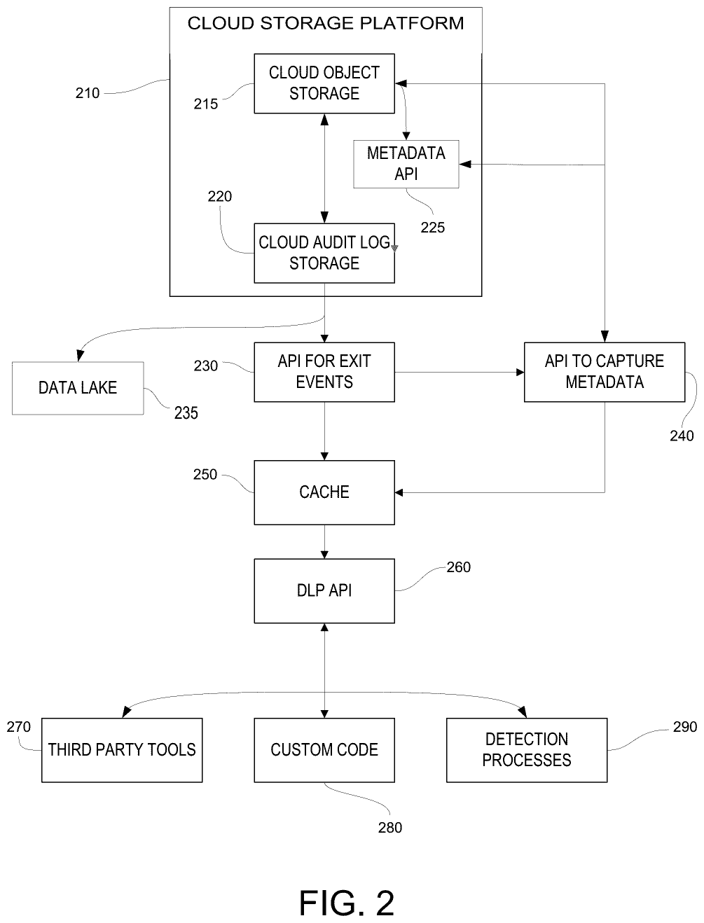

FIG. 2 shows an illustrative system diagram with a cloud storage platform 210, and various processes executed in an environment (e.g., enterprise) for maintaining metadata with one or more objects and allowing object(s) with metadata to be used with data loss prevention tools. Various portions in FIG. 2 may be performed in the cloud such as by a cloud network which may include distributed storage and computing devices such as remote servers, which may have aspects of computing devices 101 and 105, database system 140 and control processing server system 150. Other aspects may be performed at an enterprise level within an enterprise network that may include computing devices 101 and 105, database system 140 and control processing server system 150, and the enterprise's cloud service provider 150 (e.g., Amazon Web Services®, Google Cloud®, etc.).

In FIG. 2, a cloud storage platform 210, which may include many elements and APIs, is shown with cloud object storage 215, cloud audit log storage 220, and metadata API 225. In an illustrative implementation of the disclosure, which will be described in connection with FIG. 2, an object may correspond to a document. The document may be created in the cloud storage platform 210 (e.g., GWS) via one of the document creation tools (e.g., Google Docs, Google Sheets, Google Slides, Google Drawings, Google Forms) and housed or stored in the cloud object storage (e.g., Google Drive) 215. The cloud data storage platform 210 and cloud object storage 215 provide tools for providing custom metadata associated with an object. In GWS, tools (e.g., Data Protection Rules, Drive Labels, and third party tools) may be provided to allow a user to create and associate labels (custom metadata) with documents. In one example, data classification labels, which indicate an access or security level, may be created and applied to a document. GWS allows a user to set up rules for applying labels to documents. For example, if a document contains a specific type of data (e.g., social security number, address, mobile number), a GWS tool can be configured by a user to automatically classify the document with a particular data classification label (e.g., “highly confidential”, “confidential”, “not confidential”, etc.). Once the GWS tool is configured, anytime the label is applied a log may be generated. A log may also be generated anytime a document exit event occurs. The logs are stored in GWS, cloud audit log storage 220, and updated constantly.

The cloud audit log storage 220 may store log entries for API calls or other actions including when a document exit event occurs, for example, when a document is removed from the cloud storage platform 210 including the cloud object storage 215 by downloading or being attached to an email. The cloud storage platform 210 may allow the audit log to be available to resources outside the cloud storage platform 210 to be audited by a process. In one implementation, an enterprise that uses the cloud storage platform 210 may have a team member who executes an object exit event and, for example, downloads the document from the cloud object storage 215 to their local computing device (e.g., laptop, tablet, desktop, etc.) or sends an email attaching the document to an email address outside the cloud storage platform 210. The enterprise can utilize an API for exit events 230 (using an audit script) to evaluate the audit logs and intercept exit events from the logs. The API for exit events 230 may parse the document ID (e.g., document name) from the exit event and store the document ID in cache 250.

In one example, the enterprise may use software tools to stream the audit logs using tools available from their cloud provider, which may be, for example, Amazon Web Services (AWS), Microsoft Azure, Google Cloud Platform (which is different from GWS) and others. In an illustrative implementation where the cloud data storage platform 210 is GWS, the GWS Admin Audit log via the Google Reports API, is accessible to external API calls. The GWS Admin Audit log provides, for example, a record of activities performed on documents (e.g., Google Doc) stored in Google Drive including when a document is removed from Google Drive and downloaded to an external computing device outside GWS. In one example, a user may employ an AWS Lambda function to periodically monitor (e.g., every 10 minutes) the GWS Admin Audit log for updates. One skilled in the art will appreciate that AWS, a cloud provider frequently used by enterprises, provides AWS Lambda features. AWS Lambda runs as a serverless cloud function and includes ways of implementing custom code in response to events and automatically managing underlying computing resources. Examples of events include changes in state or an update, which in one aspect of this disclosure may include receiving the audit log and processing the audit log in the AWS environment. AWS Lambda can detect a new or updated audit log. Using further processes and Lambda features in an AWS environment, the AWS Lambda can export the audit log (GWS Admin Audit log) out of GWS via a live stream pipeline (e.g. Kafka, Amazon Kinesis, or the like) which may be or produced or orchestrated by an AWS Lambda function or other infrastructure.

In an illustrative AWS environment, once an AWS Lambda function detects a change in the audit log, the data (audit log) may be pushed to a load balancer. The load balancer may send the data to an AWS Lambda function, which is a log receiver. The log receiver then may forward the data to an AWS SNS (a notification service that pushes data), which pushes the data to a custom AWS SQS (simple queue service) message queue. From the custom SQS queue, the message including the data (audit log) then sends the data to an AWS Lambda function, a streaming function, which streams the data over a stream-processing platform (e.g., Apache Kafka™ streams API) to an enterprise long term data store (e.g., enterprise data lake). In addition, the above functionality described that may be implemented in an AWS environment may also be implemented by software executed locally in the enterprise environment. One of ordinary skill in the art would reasonably be able to configure software scripts to carry out the functions and processes, which are executed in the AWS environment described.

The API for exit events 230 may intercept the stream intended for data lake and consume the stream, which includes the GWS audit logs. The API for exit events 230 may parse the stream for exit events and cache the document ID for all “download” events in the cache 250. The stream including the GWS audit logs may reach the data lake 235 in parallel with the API for exit events 230.

The API for exit events 230 may forward the document ID to and trigger an API to capture metadata 240 (using a metadata enrichment script) to populate the cache 250 with the custom metadata (e.g., classification labels, sensitivity labels, data retention labels (e.g., when or how long a document is to be retained), team labels (e.g., “accounting,” “legal,” “cyber,” etc.)) corresponding to the document. In turn, the API to capture metadata 240 can make additional calls, which include the document ID, to the cloud object storage 215 and a metadata API (e.g., Labels API in the Google Workspace®) 225 to collect the custom metadata (e.g., classification labels) associated with the document. After receiving the custom metadata, the API to capture metadata 240 may update the cache 250 to store the metadata (e.g., classification labels) in association with the document ID. According to these aspects of the disclosure, a data store in the form of a cache memory can be created that maps all downloaded documents and documents emailed out of the cloud storage platform to their cloud storage based custom metadata that would have otherwise been lost upon removal of the document from the cloud storage platform. The cache 250 may be provided in the cloud by the enterprise cloud service provider, which in one implementation is in AWS. In AWS, the cache 250 may be provided by the AWS DynamoDB, which is a fast, flexible NoSQL database, which includes, among other functions, in-memory caching and data export tools.

The above described process can compile a cache of document download events and/or document email events and the custom metadata (e.g., the classification labels) applied to the documents. Next, a data loss prevention (DLP) API 260 may expose the data in the cache 250, all downloaded objects and their classifications and other labels, for consumption and use by third party tools 270, custom code 280, detection processes 290 and other integrations. Thus, instead of accessing the data directly from cache 250, third party tools 270, custom code 280, detection processes 290 and other integrations may access the DLP API 260 by making an API function call request to obtain the exposed data. For example, a third party DLP tool may make a DLP API request, and the DLP API 260 performs a requested function and returns the relevant data. Example API function calls to the DLP API 260 may include a function call, such as: /getAllDocIds, which may return the document ID for all documents that have been downloaded from cloud object storage 215 (e.g., Google Drive); /getAllDocNames, which returns the document name for all documents that have been downloaded from cloud object storage 215; /getDocMetadataBy DocId, which returns classification labels and metadata for a specific document ID; /getDocNames WithClassification, which returns names of all downloaded documents of a specific classification; and/getDocument Blocklist, which returns a list of document names that have been downloaded that is designed to be used as input for a third party tool's exact data match functionality (e.g., Symantec for network DLP, Proofpoint for email DLP, and Netskope for cloud access security broker (CASB) DLP).

In one example, the data exposed by the DLP API 260 may be used by third party tools 270, or custom code 280, to prevent the document from being printed or sent out of the enterprise environment depending on the preserved data classification label associated with the document. Illustratively, the tools 270 or custom code 280 may include DLP tools and be configured to prevent printing and certain types of emailing by using endpoint controls, which may control endpoints such as a laptop, mobile computing device, desktop computing device, etc. In another example, based on a data classification label associated with the document, the document can be prevented from being deleted to comply with the enterprise document retention policy, legal hold requirements, and/or governmental requirements such as defined in the Sarbanes Oxley Act.

In aspects of the disclosure, the document metadata may be preserved in the enterprise cloud service provider environment or enterprise environment. Thus, if the document was downloaded by an enterprise employee and the employee sent the document to a party external to the enterprise, the metadata may not travel with the document. In another example, if the employee downloaded a document with a “highly confidential” data classification label or a document marked for legal hold, and the employee attempted to send the document outside the enterprise, email DLP tools may recognize that the document is highly confidential and prevent the document from being emailed outside the enterprise. The email DLP tools (e.g., a third party tool 270) may make an API call to the DLP API 260 and the email DLP tools may be able to determine that the document should not be emailed outside the enterprise because it contains highly confidential data.

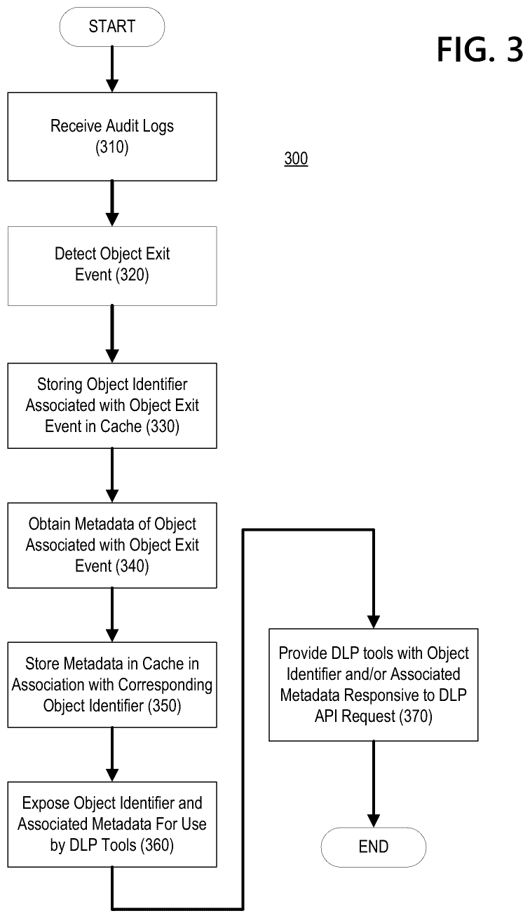

FIG. 3 provides an example process 300 for preserving custom metadata associated with an object when the object is removed from a cloud data storage platform 210 used by an enterprise according to aspects of the disclosure.

In step 310, audit logs generated by the cloud data storage platform 210 may be received (intercepted) by the enterprise from, for example, a data stream of the audit logs. The cloud data storage platform 210 may make the audit log available outside the cloud storage platform 210 to software tools, such as API calls from an API for exit events 230. The enterprise may use software tools or an API to stream the audit logs from their cloud data storage platform 210 (e.g., GWS) using tools available from their cloud provider (e.g., AWS) or, alternatively, enterprise scripts, which can be easily created by one of ordinary skill, for auditing by the API for exit events 230.

In step 320, the API for exit events 230 may detect whether exit events are present in the audit logs, which may be streamed from the enterprise cloud provider such as AWS as described previously. According to one aspect, the API for exit events 230 may parse the received audit logs to detect whether object exit events are present in the audit logs. Example object exit events include an object being downloaded to an endpoint (e.g., mobile computing device) outside the cloud data storage platform 210 or an object being attached to an email sent to an external email address.

When an object exit event is detected in step 320, in step 330, the API for exit events 230 may store an object ID of the object associated with the object exit event in cache 250. That is, the API for exit events 230 parses the object ID of the object associated with the object exit event. The object ID might be the object name or a unique identifier associated with the object.

In step 340, the API to capture metadata 240 of the object associated with the object exit event may obtain the metadata. According to one aspect, the API for exit events 230 may forward the object ID to the API to capture metadata 240. The API to capture metadata 240 may obtain custom metadata of the object associated with the object exit event by making API function calls, which may include the object ID, to the cloud object storage 215 and a metadata API 225. In response to the API function calls, the metadata API 225 may collect the custom metadata and forward the custom metadata to the API to capture metadata 240.

In step 350, the API to capture metadata 240 may store the custom metadata in association with the object document ID in the cache 250. The API to capture the metadata 240 may receive the custom metadata from the metadata API 225 and store the custom metadata. According to one aspect, downloaded objects and objects emailed out of the cloud storage platform 210 may have their custom metadata that would have otherwise been lost upon removal of the object from the cloud storage platform preserved in the cache 250.

In step 360, a DLP API 260 may then make the object ID and associated custom metadata available to third party tools 270, custom code 280, detection processes 290 and other integrations. For example, the DLP API 260 may expose the object ID and associated custom metadata for use by DLP tools. Such tools may be configured to preserve the objects according to an object retention policy or legal hold policy or may be configured to prevent documents from being printed or stored outside the enterprise.

In step 370, the DLP tools may make function calls to the DLP API 260 for the object ID and associated custom metadata, and the DLP API 260 provides the DLP tools with the object identifier and/or the associated metadata. According to one aspect, a third party DLP tool 270 may make a DLP API request. In response, the DLP API 260 may perform a requested function and return the relevant data. Example API function calls have been described above with the description of DLP API 260.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for preserving object metadata when an object exits a cloud data storage platform, the object metadata being available outside the cloud data storage platform, the method comprising:
receiving, at a computing device, audit logs generated by a cloud data storage platform;
determining, by the computing device, that the audit logs indicate a document exit event occurred from the cloud data storage platform;
storing, by the computing device and in a cache memory external to the cloud data storage platform, a document identifier of a document associated with the document exit event;
obtaining, by an Application Programming Interface (API) to capture metadata and based on the audit logs, custom metadata comprising one or more classification labels applied to the document;
storing, by the computing device, the custom metadata in the cache memory external to the cloud data storage platform in association with the document identifier;
exposing, by the computing device and to data loss prevention tools, the document identifier and the custom metadata stored in association with the document identifier in the cache memory external to the cloud data storage platform; and
preventing, by the data loss prevention tools, performance of actions on the document based on the one or more classification labels.

2. The method of claim 1, wherein the API to capture metadata calls a metadata API on the cloud data storage platform to collect the custom metadata associated with document.

3. The method of claim 1, wherein the one or more classification labels comprises a plurality of classification labels.

4. The method of claim 31, wherein the one or more classification labels comprise at least one of sensitivity labels or retention labels.

5. The method of claim 1, wherein the document exit event comprises at least one of downloading the document or emailing the document.

6. The method of claim 1, wherein the document identifier comprises a name of the document.

7. The method of claim 1, wherein the determining that the audit logs indicates a document exit event occurred comprises detecting a download of:
a document marked for legal hold.

8. The method of claim 1, wherein the determining that the audit logs indicate a document exit event occurred comprises parsing the audit logs for document exit events.

9. The method of claim 1, further comprising providing, by the computing device and based on a data loss prevention Application Programming Interface (API) request, the custom metadata for a specific document identifier.

10. The method of claim 3, wherein the method further comprises providing, by the computing device and based on a data loss prevention API request, the plurality of classification labels for a specific document identifier.

11. The method of claim 1,
wherein storing the document identifier associated with the document exit event comprises storing document identifiers associated with document exit events in the cache memory external to the cloud data storage platform, and
wherein the method further comprises providing, by the computing device and based on a data loss prevention API request, the document identifiers for documents associated with the document exit events to data loss prevention tools.

12. The method of claim 11, wherein providing, by the computing device and based on the data loss prevention API request, the document identifiers comprises providing a document name for the documents associated with the document exit events.

13. The method of claim 11, wherein the document identifiers comprise names of the documents, and the method further comprises providing, by the computing device and based on a data loss prevention API request, the names of the documents associated with the document exit events for a specific classification label.

14. The method of claim 11, wherein the document identifiers comprise names of the documents, and the method further comprises providing, by the computing device and based on a data loss prevention API request, the names of the documents associated with the document exit events, the names configured to be input for data match functionality tools.

15. An apparatus for preserving object metadata when an object exits a cloud data storage platform, the object metadata being available outside the cloud data storage platform, the apparatus comprising:
one or more processors; and
memory storing instructions that, when executed by the one or more processors, cause the apparatus to:
receive audit logs generated by a cloud data storage platform;
determine whether the audit logs identify a download event occurred from the cloud data storage platform, the download event being downloading a document on the cloud data storage platform;
store, in a cache memory external to the cloud data storage platform and based on determining that the audit logs identify a download event, a document identifier of the document associated with the download event;
obtain, by an Application Programming Interface (API) to capture metadata and based on storing the document identifier, one or more classification labels applied to the document;
store the one or more classification labels in the cache memory external to the cloud data storage platform in association with the document identifier;
expose, to data loss prevention tools, the document identifier and the one or more classification labels stored in association with the document identifier; and
prevent, by the data loss prevention tools, performance of actions on the document based on the one or more classification labels.

16. The apparatus of claim 15, wherein the instructions, when executed by the one or more processors, further cause the apparatus to:
call, by the API to capture metadata, a metadata API on the cloud data storage platform to collect the one or more classification labels associated with document.

17. The apparatus of claim 15, wherein storing the document identifier associated with the download event comprises storing, in the cache memory external to the cloud data storage platform, document identifiers associated with download events.

18. The apparatus of claim 17, wherein the instructions, when executed by the one or more processors, further cause the apparatus to:
provide, based on a data loss prevention API request, the document identifiers and the one or more classification labels for documents associated with the download events.

19. One or more non-transitory computer readable media storing instructions that, when executed by one or more processors, cause the one or more processors to perform steps for preserving object metadata when an object exits a cloud data storage platform, the object metadata being available outside the cloud data storage platform, the steps comprising:
receiving audit logs generated by a cloud data storage platform;
determining whether the audit logs identify a download event occurred from the cloud data storage platform, the download event being downloading a document;
storing, in a cache memory external to the cloud data storage platform and based on determining that the audit logs identify a download event, a document identifier of the document associated with the download event;
obtaining, by an Application Programming Interface (API) to capture metadata and based on storing the document identifier, one or more classification labels applied to the document; and
storing the one or more classification labels in the cache memory external to the cloud data storage platform in association with the document identifier;
exposing, to data loss prevention tools, the document identifier and the one or more classification labels stored in association with the document identifier; and
preventing, by the data loss prevention tools, performance of actions on the document based on the one or more classification labels.

20. The one or more non-transitory computer readable media according to claim 19, wherein the instructions, when executed, further cause the one or more processors to perform steps comprising:
calling, by the API to capture metadata, a metadata API on the cloud data storage platform to collect the one or more classification labels associated with document.
